(19) United States
(12) Patent Application Publication
(10) Pub. No.: US 2001/0032215 A1
(43) Pub. Date: Oct. 18, 2001

(54) System for completing forms

(75) Inventors: T. Rogers Kyle, Wyndmoore, PA (US); Jason E. Rappaport, Wyndmoore, PA (US)

Correspondence Address: Caesar, Rivise, Bernstein, Cohen & Pokotilow, Ltd., 12th Floor, Seven Penn Center, 1635 Market Street, Philadelphia, PA, 19103-2212, US

(73) Assignee: MDofficelinx.com, LLC

(21) Appl. No.: 09/730,441

(22) Filed: Dec. 5, 2000

Related U.S. Application Data
(60) Provisional application No. 60/170,290, filed on Dec. 10, 1999.

(51) Int. Cl. G06F 17/24

(52) U.S. Cl. 707/505; 707/530

(57) ABSTRACT

A method for providing form processing services in a form processing system having a computer, a system memory, a plurality of system forms and a plurality of system participants including a user member, an organization member, and an authenticating member for entering user member information regarding the user member into a system form of the plurality of system forms and transmitting the system form to the organization member, which includes storing the plurality of system forms in the system memory and selecting a system form of the plurality of system forms to provide a selected system form. User member information is entered into the selected system form to provide an at least partially populated system form and the at least partially populated system form is transmitted to the authenticating member. The at least partially populated system form is authenticated by the authenticating member to provide an authenticated system form and the authenticated system form is transmitted to the organization member.

### BACKGROUND OF THE INVENTION

Historically, organizations such as schools, camps, sports clubs, employers, hospitals, day care centers and other organizations or institutions have been required by state law or other agencies to maintain on file a defined set of information on associated individuals, including students, members or other enrolling or participating individuals. Typically, forms having this information have included both demographic and medical information on members that a particular governing body has mandated as information that the institution is required to have in its files. The medical information on file must be appropriately authenticated by a physician, the physician office, or other healthcare provider and/or a parent/legal guardian. Over the years, the amount and complexity of the information required has increased and made the administration of this process for all the participants, institutions, members and physician offices, more difficult and time consuming.

In addition, as the administrative complexity and effort has increased for all the parties involved in this process, healthcare providers in general have also experienced dramatic changes in the administrative burden and associated costs of operating a physicians office, particularly primary care physicians' offices and their nursing staffs. The ability of physician offices to attend to the more mundane tasks associated with the completion of these forms has created significant frustration for the physician office as well as the members and institutions that require these forms. As a result, all the participants have become increasingly frustrated by a process that is regarded as increasingly inconvenient when completing forms that are required to meet necessary regulatory standards.

In order for schools to obtain the required information they may do a bulk mailing of the required forms to the families with school children. The mailing is typically performed during April or May for enrollment the following fall. The information required can vary significantly from one jurisdiction to another. Typically, immunizations must be up to date and entered on the form. Often, a photocopy of the immunization record from the physicians' office or a photocopy of the previous year's form is not acceptable. New students are usually required to have a physical examination completed on the form as are returning students entering specific grades, for example third, sixth and eleventh grades. This form is sometimes referred to as the long form. Other returning students may use a more abbreviated form referred to as a short form. The parent/legal guardian and the physician must sign both the long and short forms. Additional forms in the mailing documenting testing for communicable diseases such as tuberculosis (Tb) are usually required for new students and all students entering ninth grade, again with a physician's signature on the form. A dentist may need to sign a dental form stating that the student is receiving dental care. Athletic forms, to be signed by parents and physicians, are required typically for all students entering grades five through twelve.

Because pediatricians, family practitioners and others appropriately remind parents that children should have a yearly physical exam throughout their developmental years, the logical parental response on receiving the forms is to schedule an examination for their child with their physician before the fall enrollment and have the forms completed at the time of the visit. Knowing which particular form, immunization, disease testing, athletic form, etc. must be completed is often difficult for the parent to confidently decide. Therefore, the forms are often blank when brought to the physician's office and rarely completed at the same time as the visit due to time constraints or other practical hurdles.

The forms received by the parents are often driven and hand-delivered to the physician's office in anticipation of the appointment. However, particularly with school forms, a significant bottleneck occurs every summer as parents and physicians who may vacation during the summer, and students who may also vacation or attend camps, attempt to get schedules coordinated before the school year starts. Several back and forth calls can be involved before resolution.

Many states under the jurisdiction of their health departments require that these forms, appropriately updated and signed, be in the possession of the school before the student attends class. Since the school needs time to review the forms for completeness they usually require that the forms be submitted in August or early September adding to the appointment-scheduling crush in July and August.

Many of the forms require at least a few minutes effort to complete. This is especially true of forms setting forth the immunization history. Since the physician must review forms of the new school year before signing, there is often insufficient time to do so during the actual visit. Also, tuberculosis testing requires a 48-72 hour period before interpretation by a physician, necessitating a return visit and evaluation before the results can be entered in the form and signed by the physician. Therefore, the family often is required to return when the form is completed for pick up. This latter process can involve another round of telephone calls as the parent attempts to find determine whether the forms are ready. While there are no official figures available a significant number of forms are lost, misplaced or accidentally discarded in the interval between the school mailing, the delivery to the physician's office, completion of the form and pick up by the family.

### SUMMARY OF THE INVENTION

A method for providing form processing services in a form processing system having a computer, a system memory, a plurality of system forms and a plurality of system participants including a user member, an organization member, and an authenticating member for entering user member information regarding the user member into a system form of the plurality of system forms and transmitting the system form to the organization member, which includes storing the plurality of system forms in the system memory and selecting a system form of the plurality of system forms to provide a selected system form. User member information is entered into the selected system form to provide an at least partially populated system form and the at least partially populated system form is transmitted to the authenticating member. The at least partially populated system form is authenticated by the authenticating member to provide an authenticated system form and the authenticated system form is transmitted to the organization member. The form processing system includes a plurality of organization members and individual forms of the plurality of forms correspond to differing organization members of the plurality of organization members. An organization member is determined in accordance with the user member to provide a determined organization member and selecting the selected system form in accordance with the determined organization member. The user member information is entered into the selected system form automatically by the computer of the form processing system and previously entered user member information can be stored in the system memory. Further user member information is entered into the selected system form automatically in accordance with the previously entered user member information. The form processing system also includes a stored system form containing the previously entered user member information. The user member information is entered into the selected system form automatically in accordance with the stored system form. The user member information is stored into the selected system form by the user member and by the authenticating member. The user member information is entered into the selected system form by the authenticating member. The selected system form can be printed prior to entering the user member information into the selected system form to provide a first printed system form. The user member information is entered into the first printed system form manually or electronically. The at least partially populated system form is printed after entering the user member information into the selected system form electronically to provide a second printed system form. The second printed system form is transmitted to the authenticating member. The second printed system form can be transmitted to the authenticating member electronically. A system form of the plurality of system forms is altered to provide an altered system form and the user member information is entered into the altered system form. The altered system form having the user member information is transmitted to the member organization. In one embodiment of the invention the user member information includes medical information, such as medications, present within the selected system form prior to the entering of the user member information. The entering of the user member information is limited to check offs of predetermined information queries within the selected system form. The content of the user member information in this embodiment is determined in accordance with public health regulation. The authenticating member obtains access to the user member information only in accordance with a user password and the authenticating member obtains the user password only in accordance with a designation by a system administrator. In one embodiment of the invention the user member is a family, or a person within the family. The authenticating member is a physician and the organization member is a school or a camp.

### BRIEF DESCRIPTION OF THE DRAWINGS

FIGS. 1A,B show a process flow representation of member form processing system 10 of the present invention.

FIG. 2 shows a process flow representation of a member information application process performed within the member form processing system of FIGS. 1A,B.

FIG. 3 shows a process flow representation of the mail application process of the member form processing system of FIGS. 1A,B.

FIG. 4 shows a process flow representation of the memorandum posting process of the member form processing system of FIGS. 1A,B.

FIG. 5 shows the physician credentials application process of the member form processing system of FIGS. 1A,B.

FIG. 6 shows the organization requirements process of the member form processing system of FIGS. 1A,B.

FIG. 7 shows a graphical representation illustrating the relationship between the applications and databases of the member form processing system of FIGS. 1A,B.

FIG. 8 shows a graphical representation illustrating the process flow between the various applications executed within the member form processing system of FIGS. 1A,B.

FIG. 9 shows an internet networking diagram illustrating the networking of the member form processing system of FIGS. 1A,B and the various users thereof.

### DETAILED DESCRIPTION OF THE INVENTION

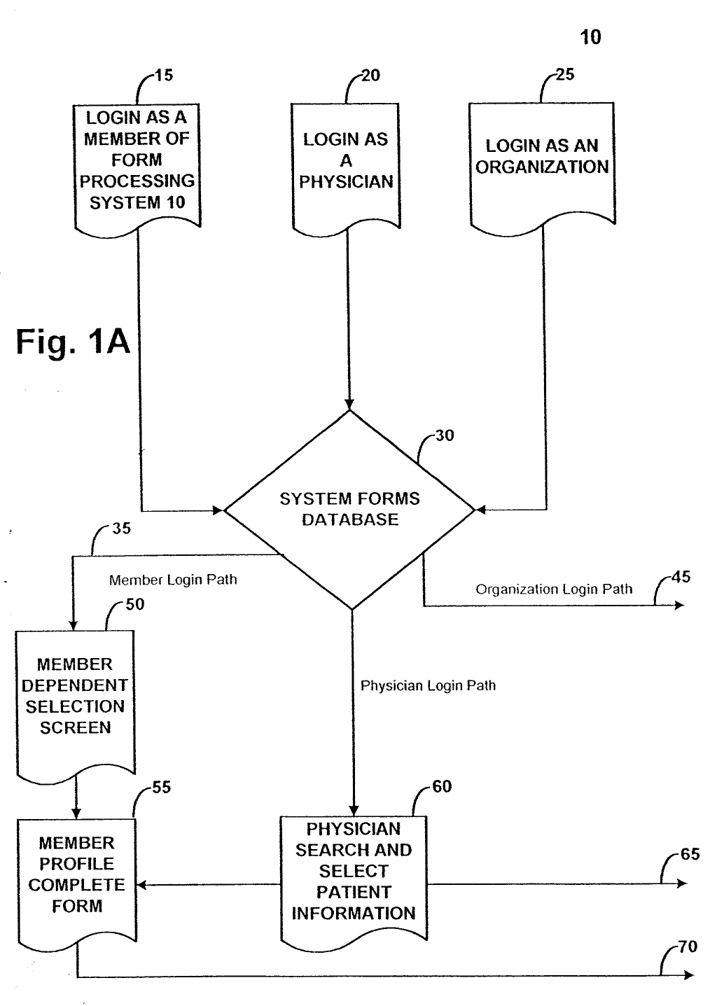

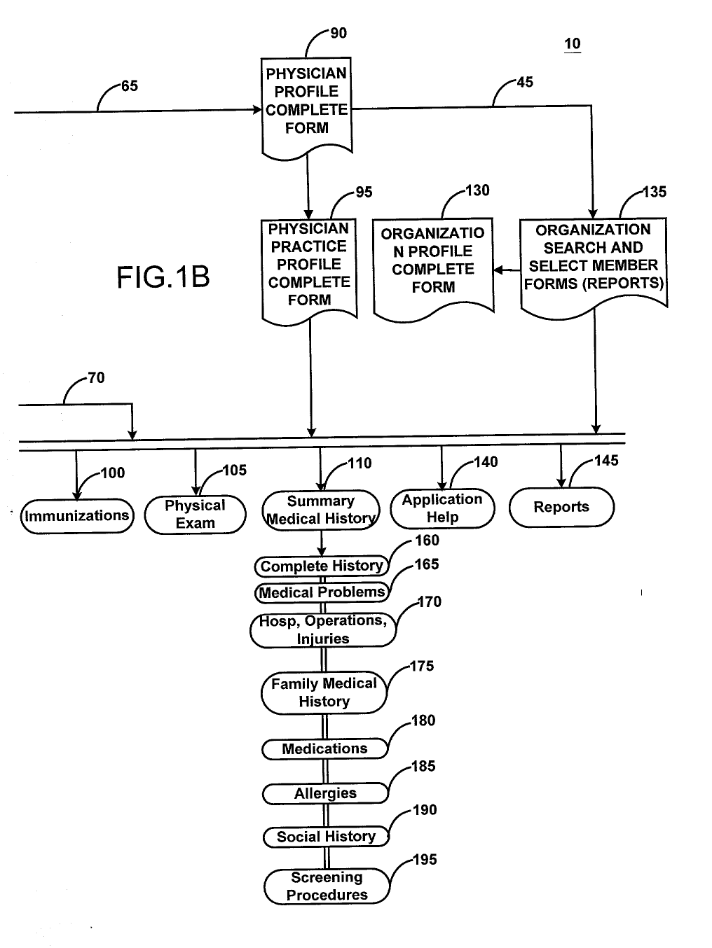

Referring now to FIGS. 1A,B, there is shown a process flow representation of member form processing system 10 of the present invention. Member form processing system 10 permits individual members thereof to obtain, populate, and authenticate member information forms required for participation in member institutions of any type that requires such forms. In order to perform the required operations member form completion system 10 facilitates the filling out and authentication of the forms by other parties in addition to the individuals. For example, member form processing system 10 facilities the from processing activities of health care providers. Furthermore, member form completion system 10 makes forms corresponding to the individual members available to member institutions are filled out and/or authenticated when they are filled out.

In order to use member form processing system 10 members must log on and establish their membership in member form processing system 10 as shown in block 15. In one preferred embodiment of the invention, the member institution can be a school and the individual member can be the students enrolling in the school or the parents or legal guardians of the students enrolling in the school.

The members of form processing system 10 select the required registration forms for their member institutions from system forms database 30 by way of member login path 35 using a selection screen as shown in block 50. The members then begin completing their forms by supplying a brief amount of demographic information as shown in block 55. In the case where the members are the parents or guardians of a minor, they can register each of the children and dependent students under their password. The members have the option of entering data, both demographic and historical medical information, in specific categories including current medical problems past medical history including hospitalizations and operations, medications, allergies, family history, and social history by way of path 70.

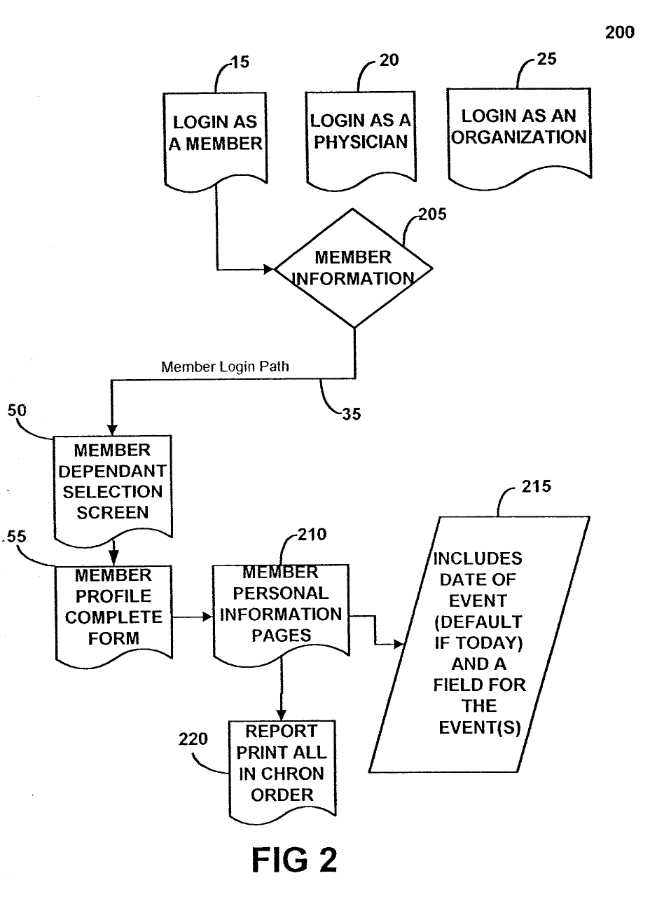

Referring now to FIG. 2, there is a process flow representation of member information application process 200. Within form processing system 10 member information application process 200 permits members to store and retrieve personal medical information in a secure manner using secure member information repository 205. The information within secure member information repository 205 can be text information associated with, for example, an event date of relevance to the member. It can be viewed, edited and added to only by the member of form processing system 10.

The member information within secure member information repository 205 can be entered or viewed by logging on with the member password as shown in block 15 and accessing the member dependant selection screen as shown in block 50 as previously described. The member can then proceed to the profile complete form screen as shown in block 55 and the member personal information pages can be accessed as shown in block 210. The member personal information pages can include such information as the date and identification of selected relevant events as shown in block 215. The member's information within member information repository 205 can be printed in chronological order by the member as shown in block 220.

In the preferred embodiment the forms obtained from system forms database 30 are in a drop down menu format and need not require or request any narrative from the party entering the data. There are data fields for the components of a physical exam within the form as well. However, only a physician with a physician verified password can authenticate the data entered in any of the medical fields. Furthermore, in one embodiment of the invention, a physician performs the authentication only after entering member form processing system 10 as shown in block 20 and selecting a form as shown in block 60.

The information on the forms is displayed as authenticated when an accompanying authentication check box for the specific entry in the data field is checked electronically by the physician. The entire data set in the medical fields can also be digitally signed by the physician when the member organization, in this example the school, and local or state governing agencies deem digital signatures acceptable. It is anticipated that this high level of authentication and security will be permitted in the near future for this process as it is utilized in other industries.

When registering their dependents members filling out forms in system 10 members can also electronically grant permission for a specified school, physician or physician practice to be permitted access to the information in the forms. The specified physician or physician practice must be registered and verified as health care providers within member form processing system 10 before access to the member records is enabled. Each time members log in and access their records or the records of their dependents a listing of the designated physicians and schools is displayed as a reminder of those currently allowed access to the records. Since there is no area in the demographic or medical information for text entries by the member a separate non-discloseable area is provided for notes that the member can use for personal reference only.

Another important component of the members record is a universal notification from the administrators of form processing system 10 that the services of form processing system 10 should not be used for any information considered too sensitive by the member for inclusion in an electronic medium. While currently available technology permits very secure storage of personal information using passwords, the passwords can inadvertently fall into unintended hands. Furthermore, computer screens can display personal information that can be viewed by persons other than the individual logged on. Therefore, an additional data field is provided that the member can check that simply informs those with permitted access to the data fields that additional information, medical or personal, exists that should be discussed directly with the member, parent, physician or other responsible party or care giver.

Organizations can temporarily enroll as institutional members of member form processing system 10. Enrolled institutions within form processing system 10 may also designate individuals to serve as contacts within the institution for interacting with the members and physician offices. A small amount of information from the institution is required. The information can include the institution name, address, description, for example, school, camp, YMCA, and a contact name, address, and phone number. Continuing with the school example, form processing system 10 contacts the institution and passwords are issued to specific individuals within the institution after the appropriate individual, the headmaster or the principal in the case of a school, consents to the terms and conditions for the use of form processing system 10. In the preferred embodiment of form processing system 10, it may be recommended that the registered nurse of the school be designated as a contact since the responsibility for cataloguing and maintaining the health forms on students typically falls to that individual.

System forms database 30 of member form processing system 10 can include any number of different forms that the various schools or other organizations or institutions may require for enrollment, sports participation, parental permission for the administration of medications, etc. It should be noted that the data fields of the forms in system forms database 30 in the broad member accessed demographic and medical information fields include all (and more) of the information needed to complete the school forms. Form processing system 10 is therefore able to customize the look of the individual forms for different member organizations and types of members by including only the pertinent data fields from the larger member fields into the specific school forms.

The fact that large amounts of information are available for the data fields of the forms within system forms database 30 permits form processing system 10 to modify and edit the informational fields in the forms as the requirements of the institutions or local school board or state health boards evolve. This saves the institution the reprinting and mailing costs required when such changes are made using prior art systems. The amount of the savings can be significant. The availability of the full range of information also permits form processing system 10 to populate the various fields within the forms with the data to be entered by the member and/or the physician's office thereby creating a nearly completed form automatically. Any medical information in the school form is clearly designated as authenticated or not authenticated by the appropriate physician. The information on the form can be updated by the member but will appear as unauthenticated until the form is either digitally signed or printed and manually signed by the physician. While physicians are the only ones who can authenticate information in the member's medically related data fields, the nursing staff can read, enter or edit unauthenticated data in the forms.

An important security component of form processing system 10 is the ability for the school or other member institution to view only the information on a selected member that they request in the specific form. The remainder of the member information, demographic or medical, is not accessible to the school. Also, only the member can designate the school as a recipient of the information by selecting the specific school from a searchable institutional member list. Any rules, regulations, announcements, notification of form changes, or other instructions that the school would typically include with the spring mailings can accompany the online forms for the reference of both the members and the physicians' office.

In view of their specific health form requirements, the school along with form processing system 10, develops a simple algorithm based on the student's age, entering grade, new or re-enrollment status, sports participation, etc. The member can enter the necessary information into the algorithm and be informed of the necessary immunizations, communicable disease testing, the need for a physical examination by the physician and which forms, long or short, need completion for fall enrollment. This guides the parent/guardian in identifying the appropriate forms that are required for each of their children. Currently schools mail copies of all the forms to all students since they do not have the resources or the historical information to individually assign particular forms to individual students.

The school or other institution also has the ability to notify the members of form processing system 10 that have selected them of any changes to policy or any changes to the forms from prior years, among other informational topics, via a notification only email system. That is, the students enrolled in a school receive information from the school via email, but the member cannot reply via email since it is anticipated that schools as yet would not be able to administer to the volume of email that this might generate. However, form processing system 10 is easily capable of altering the structure of the email system to include the ability to both send and receive email by either the school or the member.

The registered nurse of the school is the individual most commonly responsible for the forms provided by forms processing system 10. Therefore, form processing system 10 has the ability for the nurses at participating schools to have a school registered nurse network for email with other school registered nurses. Also, the school registered nurses can have email communication with their physician office counterparts as a peer-to-peer forum. In the preferred embodiment of form processing system 10 the email does not identify personal information about students when regular email accounts are used. Form processing system 10 also provides more secure methods for the discussion of health information between a school-based registered nurse and a physician's office. The more secure methods are adapted to avoid the direct transmission of any student specific information over the internet.

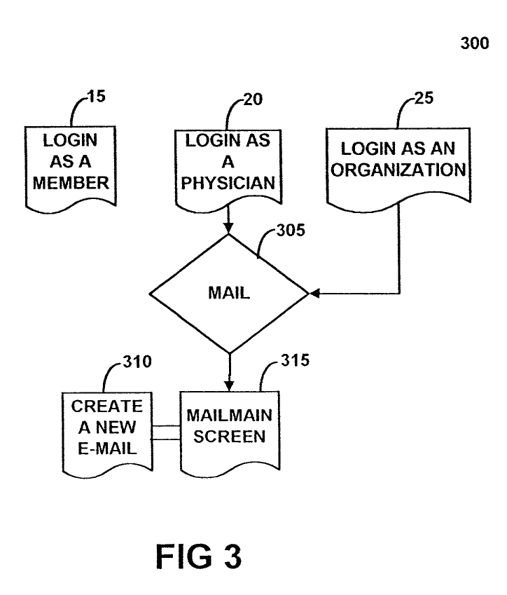

Referring now to FIG. 3, there is shown mail application process 300 of member-form processing system 10 as described herein above. Within the preferred embodiment of the invention the physicians and the organizations log on as shown in blocks 20, 25 and select mail application 305 in order to perform mail application process 300. The main mail screen of member form processing system 10 is displayed as shown in block 315 and the user is permitted to create a new email as shown in block 310. The operations performed in accordance with the new email creation of block 310 include searching the databases of system 10 to select the desired physicians and organizations for receiving the email. Additionally, a library of predefined messages is available for selection. The messages created using mail application process 300 can be delivered to the recipient by way of the internet.

Mail application process 300 is adapted to permit physicians and physician offices, in addition to organizations, to perform the one way email transmissions to members required within member form processing system 10. However, in an alternated embodiment of the invention the physicians and organizations can elect to permit two way email transmissions or encrypted or unencrypted transmissions.

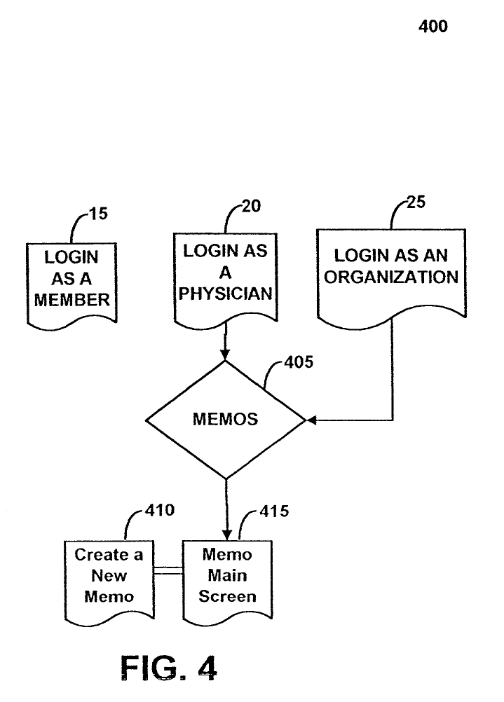

Referring now to FIG. 4, there is shown memo posting process 400 of member form processing system 10. Within the preferred embodiment of the invention the physician or organization logs on as shown in blocks 20, 25 and selects memo application 405 in order to perform memo application process 400. The main memo screen is displayed as shown in block 415 and the user is permitted to create a new memo as shown in block 410.

The operations performed in accordance with the new memo creation of block 410 include searching the databases of form processing system 10 to select the desired physicians and organizations for receiving the memo. Additionally, a library of predefined messages is available for selection by the physician or organization. The messages created using mail application process 400 can be delivered to the recipient by member form processing system 10 the next time the recipient logs on.

As an additional resource to the school and the school registered nurse, form processing system 10 offers a Medical Advisory Board composed of physicians and nurses who respond on a regular basis to institutional level health related questions or concerns. This is offered as in an advisory panel only and is not intended to be a resource in designing health policy for any institution.

Although the member institutions of form processing system 10 may receive forms with an encrypted digital signature using technologies that can be made available in form processing system 10, it is recommended that the schools continue to utilize the completed manually signed (parent and/or physician) forms for their record keeping until the institution's counsel is comfortable with digital signatures. However, the school registered nurse can always refer to the medical information of a student contained in the school form and the data entered is displayed as authenticated or not authenticated by the parent/legal guardian and/or physician. With this feature parents are able to add additional medical information, such as a new medication allergy, and alert the school and the nurse to the change. This allows the nurse to query the parent about the changes and correspond with the office of the physician if necessary.

Physicians and medical personnel in their offices can log onto form processing system 10 as shown in block 20 and proceed by way of path 65 as shown in FIGS. 1A,B to enroll online and obtain a temporary registration. The physician registration is accomplished by completing a physician profile form as shown in block 90 and/or a practice profile form as shown in block 95. During the initial process the registering physician agrees to the terms and conditions for use of form processing system 10 as a physician. The physician is provided with the option of performing the registration process by making a telephone call rather than by logging on to form processing system 10 in order to perform an online registration. An 800 telephone number can be provided for this purpose.

Once the physician has made contact with form processing system 10 a return call is placed to the physician from form processing system 10 in order to verify the information provided by the physician and compare it to information contained in various available data banks. Form processing system 10 provides individual identifications and passwords for each member of the practice, including the nursing staff, that will have access to the member information of form processing system 10.

All of those individuals in a physician's office with unique identifications and passwords can be linked by form processing system 10 allowing all participants from an individual physician office to view all members assigned to any of the participating physicians from that office. However, individual members may elect at any time to limit access to their records to only their personal physician or to selected physicians. This is useful since cross coverage at the office level is common, particularly in larger physician practices. Thus, the physician performing a physical exam may not be the physician of record for a particular student. In addition, this feature circumvents delays caused by a physician's vacation or other reason for being unavailable.

Another noteworthy capability of form processing system 10 is the access that an after hours on-call physician has to the medical information in the student's record. In the absence of other electronic records this provides the covering physician with important historical medical information on the student that would otherwise have to be obtained over the phone from the student or family. As noted previously the member must actively select the physicians office as an entity with access to the member records before the practice can view any member records. If a member changes physicians he/she simply removes the existing practice from those granted access and adds the new physician practice.

With access to a student's data, again using the example of school forms, and the accompanying school form, the office nurse can identify the student's requirements for fall enrollment since he/she has access to the school forms as well as the broader data contained in the member's record. Although this is typically a nursing function it could be performed by a physician. The school's enrollment requirements accompany the forms, as well as form processing system 10 generated algorithm described above, giving the nurse the ability to triage the student to the appropriate service in the physician's office. With the patient notification only capability also described above the family can be contacted and instructed on the necessary steps to complete the form as well as a time for an appointment to accomplish the procedure, for example immunization, Tb testing, physical exam, etc. As an alternative the nurse can still call the family if desired (or if the family does not have a computer with internet access) to arrange the necessary appointments. With either method several costly administrative steps are eliminated from the administratively complex process noted above and record keeping is greatly improved. Furthermore, the physician receives a completed form, or a nearly completed in the case of the need for a physical exam, at the time the form is given to the physician.

At this point the physician can digitally sign the form and make it available to the participating institutional member without transmitting the information over the internet. However, as noted earlier until digital signatures are more broadly accepted the physician can simply print out the completed form, sign it manually, place a copy in the student's office record and give the signed form to the student/family.

Many physician offices charge a fee for completing forms such as those processed by form processing system 10. Therefore, form processing system 10 provides a billing system that automatically bills the student/family the desired amount to an approved credit card at the physician's direction only. Form processing system 10 then forwards the funds directly to the practice on a monthly basis. This improves collection and record keeping for the office and eliminates an administrative function for the front office staff. At the direction of the physician practice the member is asked to provide the necessary credit card information when the member selects a particular physician practice for use within form processing system 10. Members of form processing system 10 are simultaneously notified that yearly charges to their credit card will not exceed a specified per member per year amount without additional consent from the member.

Member physicians can confer with other member physicians via a secure feature of form processing system 10 that permits physician-to-physician communication while referencing a common medical outline on a particular patient as previously described. Specific, patient-identifiable information is not sent over the internet and patient consent, obtained online as described above, for all physicians viewing their records must be obtained. As also noted previously, all physicians viewing particular individuals information must be members of form processing system 10.

Not all of the information storage capabilities for physician offices are related to interactive form completion. An additional repository for repetitively requested information is a database for individual physician credentials. Physicians are required to submit to lengthy lists of historical information including such specifics as medical education, residency training, office information, malpractice history and coverage, as well as various state and federal licenses, among other items. Most insurance plans adhere to the National Committee on Quality Assurance (NCQA) guidelines in order to be credentialed by this organization. Typically, insurance plans will re-credential physicians participating in their network every two years to meet NCQA guidelines for plan credentialing. One of the NCQA criteria includes having on file up-to-date information on all their participating physicians. Hospitals must also have this individual-specific information on physicians who are active members of their medical staffs to meet similar guidelines required by the Joint Commission on Accreditation for Healthcare Organizations (JCAHO). Physicians must resubmit this information every two years to each hospital where a physician maintains active staff privileges.

At present, there is no standardization for the content of the physician information forms that can be stored and processed by form processing system 10 for each institution that requires up to date credentialing information on physicians. Each such form received by physician offices must be completed by hand and obligates the office (typically an administrative person) to re-enter this data on each physician in the office every time a form is required by a hospital or insurance plan. Form processing system 10 provides for a repository for the information required on the forms that can be viewed by the physician and updated if necessary. Administrators in the office then have an updated reference tool for reference when completing the forms saving time and effort on both the physicians' and administrators' behalf.

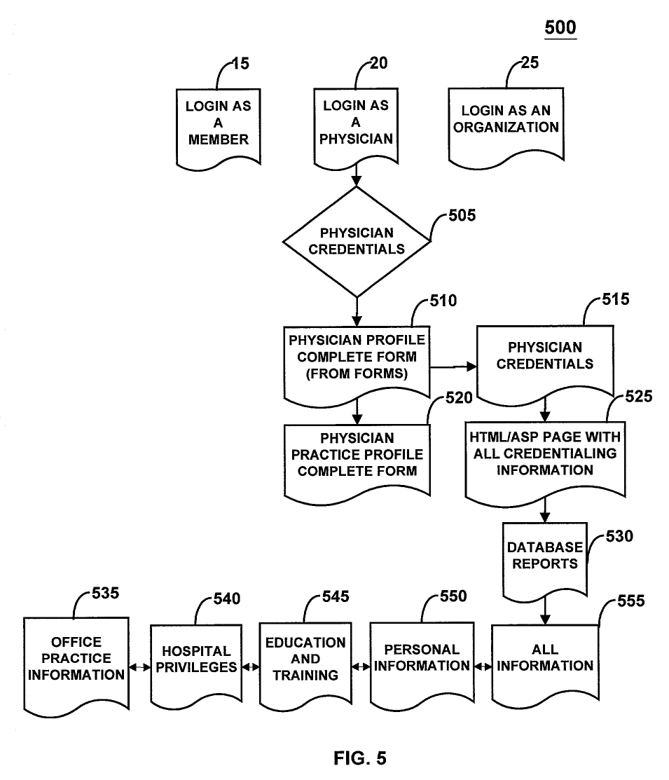

Referring now to FIG. 5, there is shown physician credentials application process 500 of member form processing system 10. In physician credentials application process 500 a physician logs on to member form processing system 10 as shown in block 20 and selects physician credentials application 505. The physician profile complete form screen is displayed for the member as shown in block 510.

The physician can either complete the practice profile form as show in block 520 by entering profile information or retrieve credential information as shown in block 515. The credential information can be provided in various formats as shown in block 525 where the physician can edit the information and database reports can be provided as shown in block 530. The database reports of block 530 can include all of the credential information available on the physician within physician credentials application 505 of member form processing system 10 as shown in block 555. Alternately, it can include subsets of the total information available such as office practice information, hospital privileges, education and training or personal information as shown in blocks 535-550.

It is noteworthy that physician office participation in form processing system 10 is desirable but not critical for the utility of the overall application. Physicians, for example, are still able to access participating institutional (school) forms from any computer with internet access and print the blank forms in the office rather than require the family/student to drop the forms off at their office. This feature is particularly useful for many instances where the form is unavailable at the time of an office visit or misplaced by any party. However, the transfer by patients/students/families of demographic or medical information requires the physician to be a member information processing system 10.

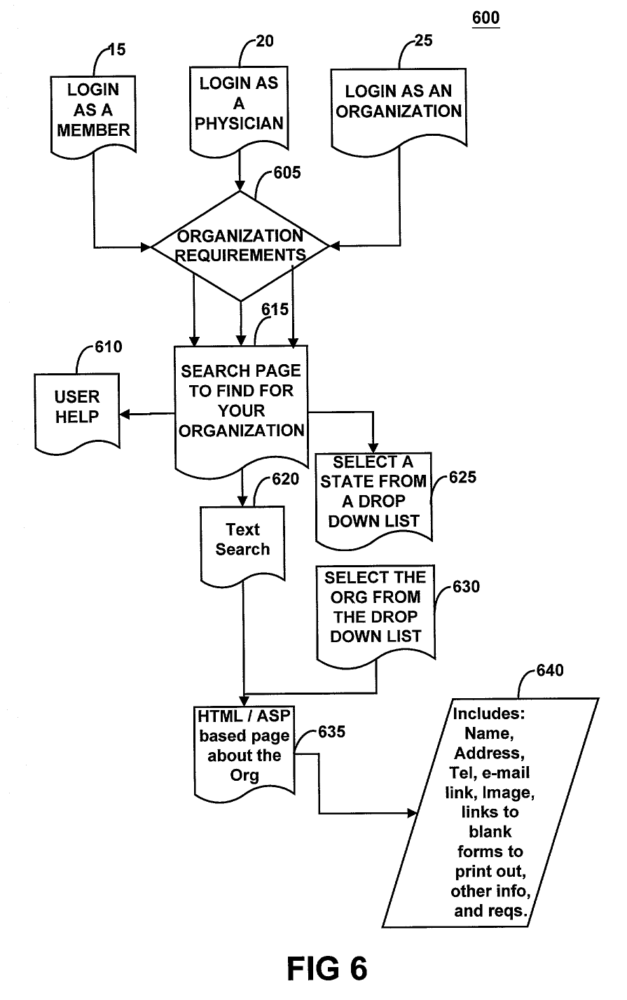

Referring now to FIG. 6, there is shown organization requirements process 600 of member form processing system 10. Using organization requirements process 600 it is possible to determine the requirements for each of the organizations being serviced within the system of the present invention. To determine organization requirements in this manner a log on is executed at blocks 15, 20 and 25 as previously described. Regardless of the type of entity logging on execution proceeds to organization requirements application 605 and to the search page for finding the organization as shown at block 615. User help is provided as shown in block 610.

The user can find the organization using a text search as shown in block 620 or by using drop down menus. When drop down menus are used a state is selected and then an organization within the selected state is selected as shown in blocks 625, 630. A page setting forth the information with respect to the requirements of the organization is displayed as shown in block 635. The parent can then enter a few pieces of information on the student (age, entering grade, new or returning student, sports participation, etc.) to automatically let the parent know which forms, immunizations, Tb testing etc. are required for the student. The requirements information obtained by the parent as well as other information about the organization are made available as shown in block 640. Furthermore, the organization information obtained in this manner is easily modifiable with changes in the schools' or states' requirements. The information about the organization can include the name, address, telephone number, email link, image, links to blank forms to be printed out, and other information and requirements.

It will be understood that the three participants in form processing system 10 as set forth herein, the member, the institution and the care giver, and their corresponding processes, are not intended to be limited to the particular examples described herein. Although the examples described herein focus on the participants requiring the processing of school forms, the same processes, technologies, logic and information loop may be applied to any number of other similar participants and processes including but not limited to camp applications, employment forms, driver's license applications, sports leagues, health clubs, etc.

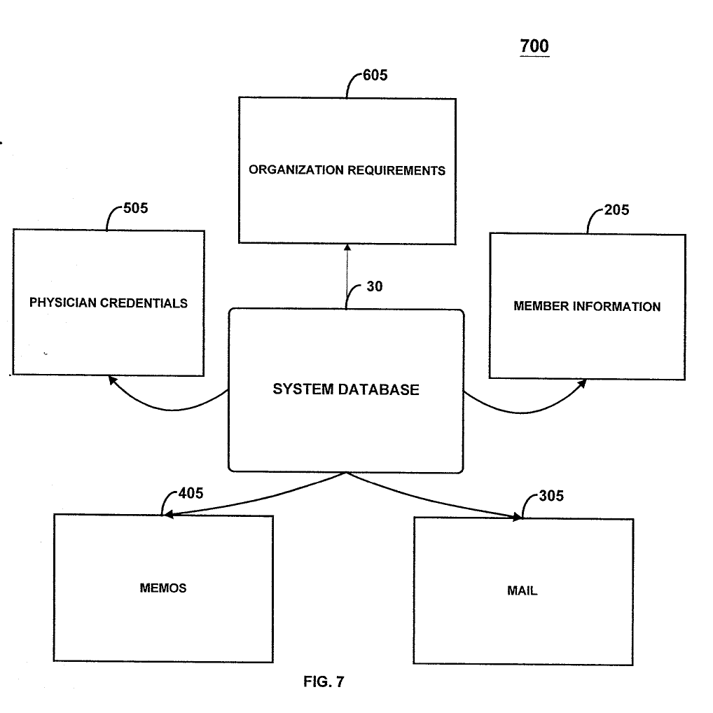

Referring now to FIG. 7, there is shown graphical representation 700. System forms database 300, the main application within the suite of applications that make up member form processing system 10, is at the center of graphical representation 700. It is within system forms database 300 that the medical information on the members various types of member form processing system 10 is stored. Additionally, the information and process flows of secure member information repository 205, mail application 305, memo application 405, physician credentials application 505 and organization requirements application 605 are included within system forms database 300.

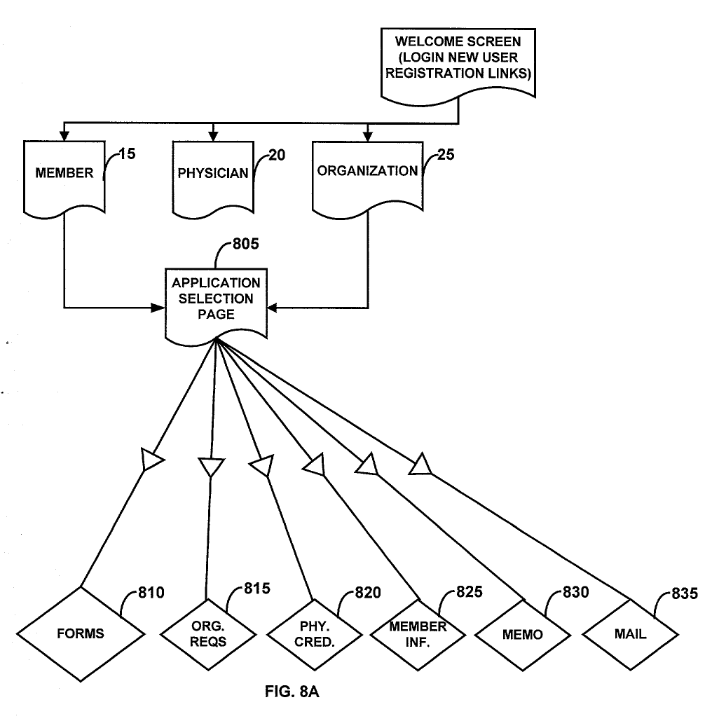

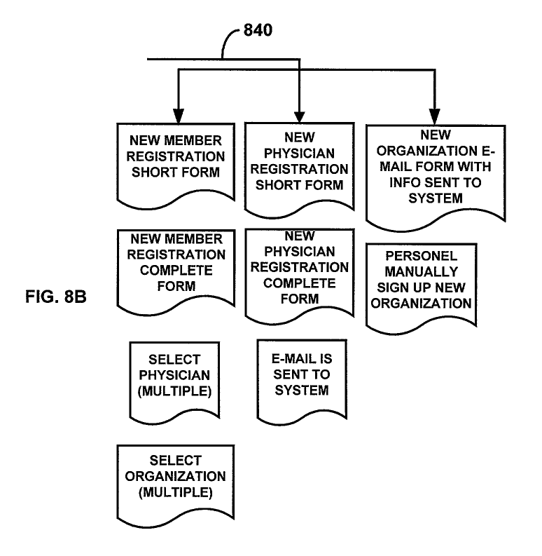

Referring now to FIG. 8, there is shown graphical representation 800. Graphical representation 800 illustrates the process flow between the applications of member form processing system 10 set forth herein above. When a user of member form processing system 10 logs on an application suite selection page is displayed as shown in block 805. The user can use the application suite selection page to select the forms application, the organization requirements application, the physician credentials application the member information application, the memo application or the mail application as shown in blocks 810-835.

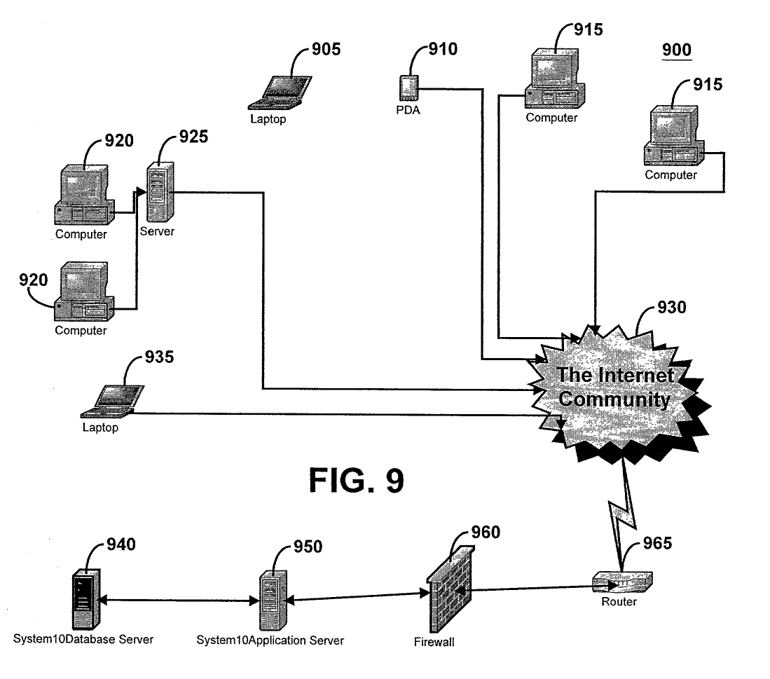

Referring now to FIG. 9, there is shown internet networking diagram 900. Internet networking diagram 900 illustrates the networking of member form processing system 10 and the various users thereof. Database server 940 within internet networking diagram 900 20 stores the data of member form processing system 10 including system forms database 30. System application server 950 is coupled to database server 940 by way of lines 945. Lines 945 between system application server 950 and database server 940 are adapted to prevent access to database server 940 by way of any address other than the network address of application server 950. Firewall 960 is disposed between application server 950 and router 965 which connects member form processing system 10 to internet community 930. Firewall 960 is required to protect the confidentiality and integrity of the data within member form processing system 10 from intruders from internet community 930.

Legitimate users of form processing system 10 can obtain access by way of internet community 930 in any of the well known ways. Users having access to personal computers 915 can log on directly using the browsers commonly available with such computers. Additionally, personal digital assistant 910 and laptops 905, 935 having internet capability can use the internet capability to connect with internet community 930 and thereby obtain access to form processing system 10. Personal computers 920 are adapted to connect with internet community 930 by way of server 925.

Although the invention has been described using specific embodiments, it is clear that alternatives, modifications, and variations will become apparent to those skilled in the art in light of the foregoing description. Accordingly, it is intended that the present invention embrace all such alternatives, modifications and variations.

We claim:

1. A method for providing form processing services in a form processing system having a computer, a system memory, a plurality of system forms and a plurality of system participants including a user member, an organization member, and an authenticating member for entering user member information regarding the user member into a system form of the plurality of system forms and transmitting the system form to the organization member, comprising the steps of:
(a) storing the plurality of system forms in the system memory;
(b) selecting a system form of the plurality of system forms to provide a selected system form;
(c) entering user member information into the selected system form to provide an at least partially populated system form;
(d) transmitting the at least partially populated system form to the authenticating member;
(e) authenticating the at least partially populated system form by the authenticating member to provide an authenticated system form; and
(f) transmitting the authenticated system form to the organization member.

2. The method for providing form processing services of claim 1, wherein the form processing system includes a plurality of organization members and individual forms of the plurality of forms correspond to differing organization members of the plurality of organization members, further comprising the steps of:
(a) determining an organization member in accordance with the user member to provide a determined organization member; and
(b) selecting the selected system form in accordance with the determined organization member.

3. The method for providing form processing services of claim 1, further comprising the step of entering user member information into the selected system form automatically by the computer of the form processing system.

4. The method for providing form processing services of claim 3, wherein the form processing system includes previously entered user member information stored in the system memory, further comprising the step of entering further user member information into the selected system form automatically in accordance with the previously entered user member information.

5. The method for providing form processing services of claim 4, wherein the form processing system includes a stored system form containing the previously entered user member information, further comprising the step of entering user member information into the selected system form automatically in accordance with the stored system form.

6. The method for providing form processing services of claim 1, further comprising the step of entering user member information into the selected system form by the user member.

7. The method for providing form processing services of claim 1, further comprising the step of entering user member information into the selected system form by the authenticating member.

8. The method for providing form processing services of claim 4, further comprising the step of entering user member information into the selected system form by the authenticating member.

9. The method for providing form processing services of claim 1, further comprising the step of printing the selected system form prior to entering the user member information into the selected system form to provide a first printed system form.

10. The method for providing form processing services of claim 9, further comprising the step of manually entering the user member information into the first printed system form.

11. The method for providing form processing services of claim 1, further comprising the step of entering the user member information into the selected system form electronically.

12. The method for providing form processing services of claim 11, further comprising the steps of:
(a) printing the at least partially populated system form after entering the user member information into the selected system form electronically to provide a second printed system form; and
(b) transmitting the second printed system form to the authenticating member.

13. The method for providing form processing services of claim 12, further comprising the step of transmitting the second printed system form to the authenticating member electronically.

14. The method for providing form processing services of claim 1, further comprising the steps of:
(a) altering a system form of the plurality of system forms to provide an altered system form;
(b) entering the user member information into the altered system form;
and
(c) transmitting the altered system form having the user member information to the member organization.

15. The method for providing form processing services of claim 1, wherein the user member information comprises medical information.

16. The method for providing form processing services of claim 15, wherein at least a portion of the user member information is present within the selected system form prior to the entering of the user member information.

17. The method for providing form processing services of claim 15, wherein the entering of the user member information is limited to check offs of predetermined information queries within the selected system form.

18. The method for providing form processing services of claim 15, wherein the user member information includes information with respect to medications.

19. The method for providing form processing services of claim 15, wherein the content of the user member information is determined in accordance with public health regulation.

20. The method for providing form processing services of claim 1, wherein the authenticating member obtains access to the user member information only in accordance with a user password.

21. The method for providing form processing services of claim 20, wherein the form processing system includes a system administrator for performing administration of the form processing system and the authenticating member obtains the user password only in accordance with a designation by the system administrator.

22. The method for providing form processing services of claim 2, wherein the user member comprises a family.

23. The method for providing form processing services of claim 22, wherein the user member comprises a person within the family.

24. The method for providing form processing services of claim 22, wherein the authenticating member comprises a physician.

25. The method for providing form processing services of claim 22, wherein the organization member comprises a school.

26. The method for providing form processing services of claim 22, wherein the organization member comprises a camp.

27. A form processing system having a computer, a system memory and a plurality of system participants including a user member, an organization member, and an authenticating member for entering user member information regarding the user member into a system form of the plurality of system forms and transmitting the system form to the organization member, comprising:
(a) a plurality of systems forms stored within the system memory;
(b) a selected system form selected from the plurality of system forms;
(c) user member information disposed in the selected system form to provide an at least partially populated system form;
(d) a first transmitted form provided by transmitting the at least partially populated system form to the authenticating member;
(e) an authenticated form provided by authenticating the at least partially populated system form by the authenticating member; and
(f) a second transmitted form provided by transmitting the authenticated system form to the organization member.

28. The form processing system of claim 27, including a plurality of organization members and individual forms of the plurality of forms corresponding to differing organization members of the plurality of organization members, further comprising:
(a) a determined organization member determined in accordance with the user member; and
(b) a selected system form selected in accordance with the determined organization member.

29. The form processing system of claim 7, including a stored system form containing previously entered information regarding said user, wherein said user member information is disposed in the selected system form after the previously entered information.

30. The form processing system of claim 27, further comprising a first printed system form provided by printing the selected system form prior to entering the user member information into the selected system form.

31. The form processing system of claim 30, further comprising a second printed system form provided by printing the at least partially populated system form after electronically entering the user member information into the selected system form.

32. The form processing system of claim 27, further comprising:
(a) an altered system form provided by altering a system form of the plurality of system forms;
(b) a populated altered form provided by entering the user member information into the altered system form; and
(c) a transmitted altered form provided by transmitting the altered system form having the user member information to the member organization.

33. The form processing system of claim 27, wherein the user member information comprises medical information.

34. The method for providing form processing services of claim 27, further comprising a password wherein the authenticating member obtains access to the user member information only in accordance with a user password.
